(19) United States
(12) Patent Application Publication
(10) Pub. No.: US 2026/0246347 A1
(43) Pub. Date: Aug. 20, 2026

(54) MOTOR DEVICE AND OPERATION METHOD THEREOF

(71) Applicant: Delta Electronics, Inc., Taoyuan City (TW)

(72) Inventor: Kuo-Heng CHAO, Taoyuan City (TW)

(21) Appl. No.: 19/219,531

(22) Filed: May 27, 2025

(30) Foreign Application Priority Data
Feb. 18, 2025 (TW) 114105823

(51) Int. Cl. H02K 11/33; H02K 11/00

(52) U.S. Cl. CPC H02K 11/33; H02K 11/0094; H02K 2211/00; H02K 2213/06

(57) ABSTRACT

A motor device includes an inverter, a driver, and a control module. The inverter includes a first switch module and a second switch module. When an abnormality occurs in the motor device, in the first short-circuit protection mode, the control module generates a first control signal to control the driver to generate a first driving signal to the first switch module and the second switch module, so that the first switch module and the second switch module are turned off. When the first short-circuit protection mode is switched to the second short-circuit protection mode, the control module generates a second control signal to control the driver to generate a second driving signal to the first switch module or the second switch module, so that the first switch module or the second switch module is turned on. The second control signal is a pulse width modulation signal.

### CROSS REFERENCE TO RELATED APPLICATIONS

This application claims priority of Taiwan Patent Application No. 114105823, filed on Feb. 18, 2024, the entirety of which is incorporated by reference herein.

### BACKGROUND OF THE INVENTION

### Field of the Invention

The present invention relates to a motor device, and in particular it relates to a motor device and an operation method thereof capable of reducing transient current.

### Description of the Related Art

Generally speaking, in the motor device applications of electric vehicles, the battery, the motor controller and the motors are the three major components that make up the electric vehicle drive system. The battery is the power source responsible for providing or storing energy, the motor converts the electrical energy and the mechanical energy, and the motor controller controls the energy conversion between the motor and the battery to achieve the purpose of controlling the acceleration and deceleration of the vehicle.

However, when an abnormality occurs in the drive system, the energy conversion between the battery and the motor may need to be cut off to block the current flow between the battery and the motor. Most electric vehicles today use a permanent magnet synchronous motor (PMSM), but the internal magnets of a permanent magnet synchronous motor may generate back electromotive force, which causes a transient current surge when the connection between the battery and the motor is cut off. However, the maximum current of the transient current surge may be twice the steady-state current, and such a transient current surge may cause overheating or a lifespan reduction of the power switch. Therefore, how to effectively reduce the transient current has become an important issue.

### BRIEF SUMMARY OF THE INVENTION

An embodiment of the present invention provides a motor device and an operation method thereof, thereby effectively reducing the transient current avoid overheating or lifespan reduction of the power switch.

An embodiment of the present invention provides a motor device, which includes an inverter, a driver, and a control module. The inverter includes a first switch module and a second switch module. The first switch module is coupled to the second switch module. The driver is coupled to the first switch module and the second switch module. The control module is coupled to the driver. When an abnormality occurs in the motor device, in the first short-circuit protection mode, the control module is configured to generate a first control signal to control the driver to generate a first driving signal to the first switch module and the second switch module of the inverter, so that the first switch module and the second switch module are turned off. When the first short-circuit protection mode is switched to the second short-circuit protection mode, the control module is configured to generate a second control signal to control the driver to generate a second driving signal to the first switch module or the second switch module of the inverter, so that the first switch module or the second switch module is turned on. The second control signal is a pulse width modulation signal.

An embodiment of the present invention provides an operation method of a motor device, which includes the following steps. An inverter comprising a first switch module and a second switch module is provided, wherein the first switch module is coupled to the second switch module. A driver coupled to the first switch module and the second switch module is provided. A control module coupled to the driver is provided. When an abnormality occurs in the motor device, in the first short-circuit protection mode, the control module is used to generate a first control signal to control the driver to generate a first driving signal to the first switch module and the second switch module of the inverter, so that the first switch module and the second switch module are turned off. When the first short-circuit protection mode is switched to the second short-circuit protection mode, the control module is used to generate a second control signal to control the driver to generate a second driving signal to the first switch module or the second switch module of the inverter, so that the first switch module or the second switch module is turned on. The second control signal is a pulse width modulation signal.

According to the motor device and the operation method thereof disclosed by the present invention, when the abnormality occurs in the motor device, in the first short-circuit protection mode, the control module generates the first control signal to control the driver to generate the first driving signal to the first switch module and the second switch module of the inverter, so that the first switch module and the second switch module are turned off, so that the first switch module and the second switch module are turned off, and when the first short-circuit protection mode is switched to the second short-circuit protection mode, the control module generates the second control signal to control the driver to generate the second driving signal to the first switch module or the second switch module of the inverter, so that the first switch module or the second switch module is turned on. The second control signal is a pulse width modulation signal. Therefore, the transient current may be effectively reduced to avoid overheating or lifespan reduction of the power switch (such as the first switch module and the second switch module), and the selection of oversized power switches can be avoided, thereby achieving the purpose of reducing costs.

### BRIEF DESCRIPTION OF THE DRAWINGS

The present invention can be more fully understood by reading the subsequent detailed description and examples with references made to the accompanying drawings, wherein:

FIG. 1 is a schematic view of a motor device according an embodiment of the present invention;

FIG. 2 is a waveform diagram of a first control signal and a second control signal according an embodiment of the present invention;

FIG. 3 is a schematic view of a motor device according another embodiment of the present invention;

FIG. 4 is a waveform diagram of a first indication signal, a second indication signal, a third control signal and a fourth control signal according an embodiment of the present invention;

FIG. 5 is a detailed schematic view of a safety logic module according an embodiment of the present invention;

FIG. 6 is a flowchart of an operation method of a motor device according an embodiment of the present invention; and

FIG. 7 is a flowchart of an operation method of a motor device according another embodiment of the present invention; and

FIG. 8 is a flowchart of an operation method of a motor device according another embodiment of the present invention.

### DETAILED DESCRIPTION OF THE INVENTION

Technical terms of the present invention are based on general definition in the technical field of the present invention. If the present invention describes or explains one or some terms, definition of the terms is based on the description or explanation of the present invention. Each of the disclosed embodiments has one or more technical features. In possible implementation, a person skilled in the art would selectively implement all or some technical features of any embodiment of the present invention or selectively combine all or some technical features of the embodiments of the present invention.

In each of the following embodiments, the same reference number represents an element or component that is the same or similar.

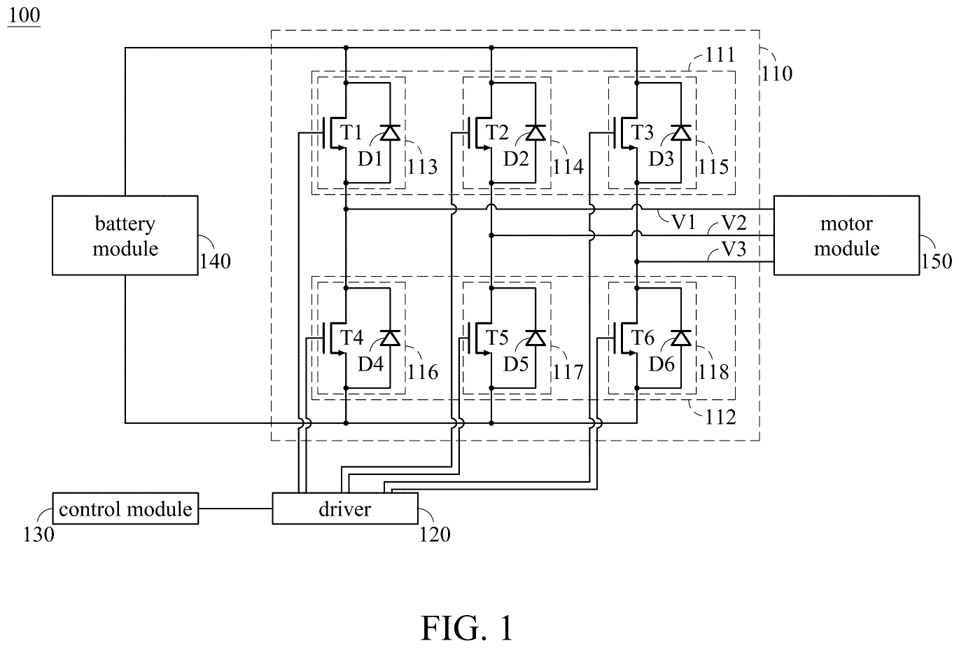

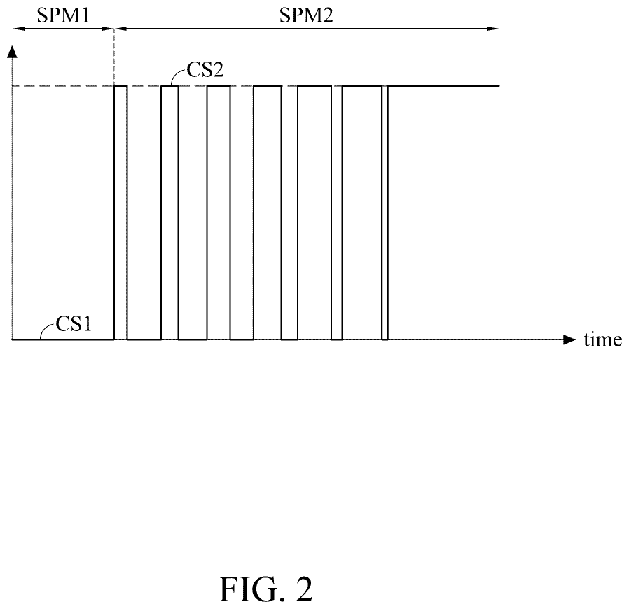

FIG. 1 is a schematic view of a motor device according an embodiment of the present invention. FIG. 2 is a waveform diagram of a first control signal and a second control signal according an embodiment of the present invention. Please refer to FIG. 1 and FIG. 2, the motor device 100 may include an inverter 110, a driver 120 and a control module 130.

The inverter 110 may include a first switch module 111 and a second switch module 112, and the first switch module 111 is coupled to the second switch module 112. The driver 120 may be coupled to the first switch module 111 and the second switch module 112. The control module 130 may be coupled to the driver 120.

In the embodiment, the control module 130 may generate a corresponding control signal to control the driver 120 to generate a corresponding driving signal, so that the first switch module 111 and the second switch module 112 of the inverter 110 perform corresponding operations. For example, the first switch module 111 and the second switch module 112 may be turned on or turned off according to the driving signal generated by the driver 120. In addition, the control module 130 may monitor the operation information of the motor device 100 to determine whether an abnormality occurs in the motor device 100. In some embodiments, the operation information of the motor device 100 may include voltage, current, speed, etc., but the embodiment of the present invention is not limited thereto. In some embodiments, the control module 130 may be a micro control unit (MCU), but the embodiment of the present invention is not limited thereto.

When an abnormality occurs in the motor device 100, in the first short-circuit protection mode SPM1, the control module 130 may generate a first control signal CS1 to control the driver 120 to generate a first driving signal to the first switch module 111 and the second switch module 112 of the inverter 110, so that the first switch module 111 and the second switch module 112 are turned off. In the embodiment, the first control signal CS1 is, for example, a low voltage level, and the driving signal is, for example, a low voltage level, but the embodiment of the present invention is not limited thereto. In some embodiments, the driver 120 has a signal amplification function, i.e., the driver 120 may amplify the first control signal CS1 to generate the corresponding first driving signal. Therefore, the amplitude of the first control signal CS1 is, for example, different from the amplitude of the first driving signal.

Then, when the first short-circuit protection mode SPM1 is switched to the second short-circuit protection mode SPM2, the control module 130 may generate a second control signal CS2 to control the driver 120 to generate a second driving signal to the first switch module 111 or the second switch module 112 of the inverter 110, so that the first switch module 111 or the second switch module 112 is turned on, wherein the second control signal CS2 is, for example, a pulse width modulation (PWM) signal. In some embodiments, the driver 120 may also amplify the second control signal CS2 to generate the corresponding second driving signal. Therefore, the amplitude of the second control signal CS2 is, for example, different from the second driving signal.

That is, in the second short-circuit protection mode SPM2, the first switch module 111 is turned on, and the second switch module 112 still maintains to be turned off, or in the second short-circuit protection mode SPM2, the second switch module 112 is turned on, and the first switch module 111 still maintains to be turned off. Therefore, the transient current may be effectively reduced to avoid overheating or lifespan reduction of the power switch (such as the first switch module 111 and the second switch module 112).

In some embodiments, the duty cycle of the second control signal CS2 may gradually increase from a first ratio to a second ratio, and the first ratio is greater than the second ratio, as shown in FIG. 2. In some embodiments, the first ratio is, for example, 0%, and the second ratio is, for example, 100%.

For example, in some embodiments, the duty cycle of the second control signal CS2 is, for example, 0%, 20%, 40%, 60%, 80% and 100% in sequence. In some embodiments, the duty cycle of the second control signal CS2 is, for example, 0%, 10%, 20%, 30%, 40%, 50%, 60%, 70%, 80%, 90% and 100% in sequence. That is, the increasing ratio of the duty cycle of the second control signal CS2 may be adjusted by the user according to the requirements, and the same technical effect may still be achieved.

In some embodiments, the first switch module 111 may include a first switch unit 113, a second switch unit 114 and a third switch unit 115. The first switch unit 113 may include a first terminal, a second terminal, and a control terminal. The second terminal of the first switch unit 113 may generate a first voltage V1. The control terminal of the first switch unit 113 may be coupled to the driver 120. Furthermore, the first switch unit 113 may include a first transistor T1 and a first diode D1.

The first transistor T1 may include a first terminal, a second terminal, and a control terminal. The first terminal of the first transistor T1 may be coupled to the first terminal of the first switch unit 113. The second terminal of the first transistor T1 may be coupled to the second terminal of the first switch unit 113. The control terminal of the first transistor T1 may be coupled to the control terminal of the first switch unit 113. The first diode D1 may include a first terminal (such as a cathode terminal) and a second terminal (such as an anode terminal). The first terminal of the first diode D1 may be coupled to the first terminal of the first transistor T1. The second terminal of the first diode D1 may be coupled to the second terminal of the first transistor T1.

The second switch unit 114 may include a first terminal, a second terminal, and a control terminal. The first terminal of the second switch unit 114 may be coupled to the first terminal of the first switch unit 113. The second terminal of the second switch unit 114 may generate a second voltage V2. The control terminal of the second switch unit 114 may be coupled to the driver 120. Furthermore, the second switch module 114 may include a second transistor T2 and a second diode D2.

The second transistor T2 may include a first terminal, a second terminal, and a control terminal. The first terminal of the second transistor T2 may be coupled to the first terminal of the second switch module 114. The second terminal of the second transistor T2 may be coupled to the second terminal of the second switch module 114. The control terminal of the second transistor T2 may be coupled to the control terminal of the second switch unit 114. The second diode D2 may include a first terminal (such as a cathode terminal) and a second terminal (such as an anode terminal). The first terminal of the second diode D2 may be coupled to the first terminal of the second transistor T2. The second terminal of the second diode D2 may be coupled to the second terminal of the second transistor T2.

The third switch unit 115 may include a first terminal, a second terminal, and a control terminal. The first terminal of the third switch unit 115 may be coupled to the first terminal of the second switch unit 114. The second terminal of the third switch unit 115 may generate a third voltage V3. The control terminal of the third switch unit 115 may be coupled to the driver 120. Furthermore, the third switch unit 115 may include a third transistor T3 and a third diode D3.

The third transistor T3 may include a first terminal, a second terminal, and a control terminal. The first terminal of the third transistor T3 may be coupled to the first terminal of the third switch unit 115. The second terminal of the third transistor T3 may be coupled to the second terminal of the third switch unit 115. The control terminal of the third transistor T3 may be coupled to the control terminal of the third switch unit 115. The third diode D3 may include a first terminal (such as a cathode terminal) and a second terminal (such as an anode terminal). The first terminal of the third diode D3 may be coupled to the first terminal of the third transistor T3. The second terminal of the third diode D3 may be coupled to the third transistor T3.

In some embodiments, the second switch module 112 may include a fourth switch unit 116, a fifth switch unit 117 and a sixth switch unit 118. The fourth switch unit 116 may include a first terminal, a second terminal, and a control terminal. The first terminal of the fourth switch unit 116 may be coupled to the second terminal of the first switch unit 113. The control terminal of the fourth switch unit 116 may be coupled to the driver 120. Furthermore, the fourth switch unit 116 may include a fourth transistor T4 and a fourth diode D4.

The fourth transistor T4 may include a first terminal, a second terminal, and a control terminal. The first terminal of the fourth transistor T4 may be coupled to the first terminal of the fourth switch unit 116. The second terminal of the fourth transistor T4 may be coupled to the second terminal of the fourth transistor 116. The control terminal of the fourth transistor T4 may be coupled to the control terminal of the fourth switch unit 116. The fourth diode D4 may include a first terminal (such as a cathode terminal) and a second terminal (such as an anode terminal). The first terminal of the fourth diode D4 may be coupled to the first terminal of the fourth transistor T4. The second terminal of the fourth diode D4 may be coupled to the second terminal of the fourth transistorT4.

The fifth switch unit 117 may include a first terminal, a second terminal, and a control terminal. The first terminal of the fifth switch unit 117 may be coupled to the second terminal of the second switch unit 114. The second terminal of the fifth switch unit 117 may be coupled to the second terminal of the fourth switch unit 116. The control terminal of the fifth switch unit 117 may be coupled to the driver 120. Furthermore, the fifth switch unit 117 may include a fifth transistor T5 and a fifth diodeD5.

The fifth transistor T5 may include a first terminal, a second terminal, and a control terminal. The first terminal of the fifth transistor T5 may be coupled to the first terminal of the fifth switch unit 117. The second terminal of the fifth transistor T5 may be coupled to the second terminal of the fifth switch unit 117. The control terminal of the fifth transistor T5 may be coupled to the control terminal of the fifth switch unit 117. The fifth diode D5 may include a first terminal (such as a cathode terminal) and a second terminal (such as an anode terminal). The first terminal of the fifth diode D5 may be coupled to the first terminal of the fifth transistor T5. The second terminal of the fifth diode D5 may be coupled to the second terminal of the fifth transistor T5.

The sixth switch unit 118 may include a first terminal, a second terminal, and a control terminal. The first terminal of the sixth switch unit 118 may be coupled to the second terminal of the third switch unit 115. The second terminal of the sixth switch unit 118 may be coupled to the second terminal of the fifth switch unit 117. The control terminal of the sixth switch unit 118 may be coupled to the driver 120. Furthermore, the sixth switch unit 118 may include a sixth transistor T6 and a sixth diode D6.

The sixth transistor T6 may include a first terminal, a second terminal, and a control terminal. The first terminal of the sixth transistor T6 may be coupled to the first terminal of the sixth transistor 118. The second terminal of the sixth transistor T6 may be coupled to the second terminal of the sixth switch unit 118. The control terminal of the sixth transistor T6 may be coupled to the control terminal of the sixth switch unit 118. The sixth diode D6 may include a first terminal (such as a cathode terminal) and a second terminal (such as an anode terminal). The first terminal of the sixth diode D6 may be coupled to the first terminal of the sixth transistor T6. The second terminal of the sixth diode D6 may be coupled to the second terminal of the sixth transistor T6.

In addition, in the embodiment, each of the first transistor T1~the sixth transistor T6 may be an N-type transistor, wherein the first terminal of each of the first transistor T1~the sixth transistor T6 may be a drain terminal of the N-type transistor, the second terminal of the first transistor T1~the sixth transistor may be a source terminal of the N-type transistor, and the control terminal of the first transistor T1~the sixth transistor T6 may be a gate terminal of the N-type transistor, but the embodiment of the present invention is not limited thereto. In other embodiments, each of the first transistor T1~the sixth transistor T6 may also be a P-type transistor or another suitable transistor.

Furthermore, in some embodiments, in the first short-circuit protection mode SPM1, the first transistor T1~the sixth transistor T6 are turned off at the same time, i.e., the first short-circuit protection mode SPM1 may be a six-switch-off (6SO—6 Switch Open) mode. In the second short-circuit protection mode SPM2, the first transistor T1~the third transistor T3 are turned on at the same time, or the fourth transistor T4~the sixth transistor T6 are turned on at the same time, i.e., the second short-circuit protection mode SPM2 may be an active short circuit (3PS—3 Phase Short) mode.

Furthermore, in some embodiments, the motor device 100 may further include a battery module 140 and a motor module 150. The battery module 140 may be coupled to the first terminal of the first switch unit 113 and the second terminal of the fourth switch unit 116, i.e., the battery module 140 may be coupled to the inverter 110. The battery module 140 may provide a power source to the inverter 110, and the inverter 110 may determine whether to provide a first voltage V1, a second voltage V2 and a third voltage V3 according to the power source provided by the battery module 140 according to the driving of the driver 120.

The motor module 150 may be coupled to the second terminal of the first switch unit 113, the second terminal of the second switch unit 114 and the second terminal of the third switch unit 115, i.e., the motor module 150 may be coupled to the inverter 110. The motor module 150 may receive the first voltage V1, the second voltage V2 and the third voltage V3, and operate according to the first voltage V1, the second voltage V2 and the third voltage V3. In addition, the first voltage V1, the second voltage V2 and the third voltage V3 may be three-phase voltages provided to the motor device 150 for operation. In some embodiments, the motor module 150 may be a permanent magnet synchronous motor (PMSM), but the embodiment of the present invention is not limited thereto.

In some embodiments, I_{U} is the current generated by the inverter 110 and may calculated by equation (1), and equation (1) is as follows:

$${I}_{U} = {K}_{1} [ 2 {V}_{d c} ( D - 1 ) + 3 {e}_{U} ] \qquad ( 1 )$$

wherein I_{U} is the current generated by the inverter 110, K₁ is a constant, V_{dc} is the power source provided by the battery module 140, D is the duty cycle of the second control signal CS2, and e_{U} is the back electromotive force generated by the motor module 150. As can be seen from equation (1), the motor device 100 may adjust the duty cycle D of the second control signal CS2 through the control device 130 to adjust the current I_{U} generated by the inverter 110, thereby achieving the purpose of reducing the transient current.

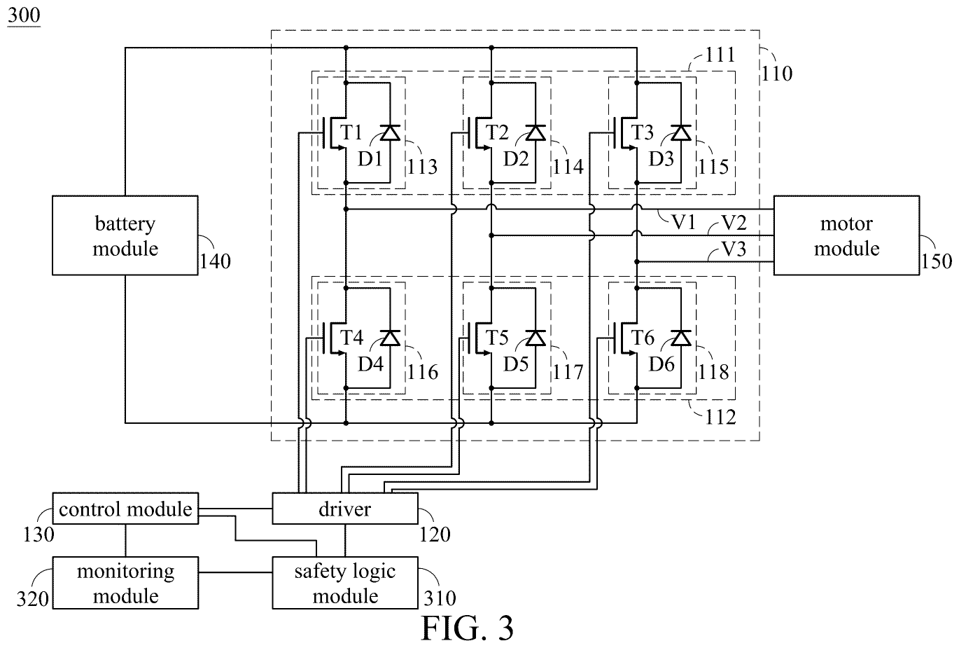

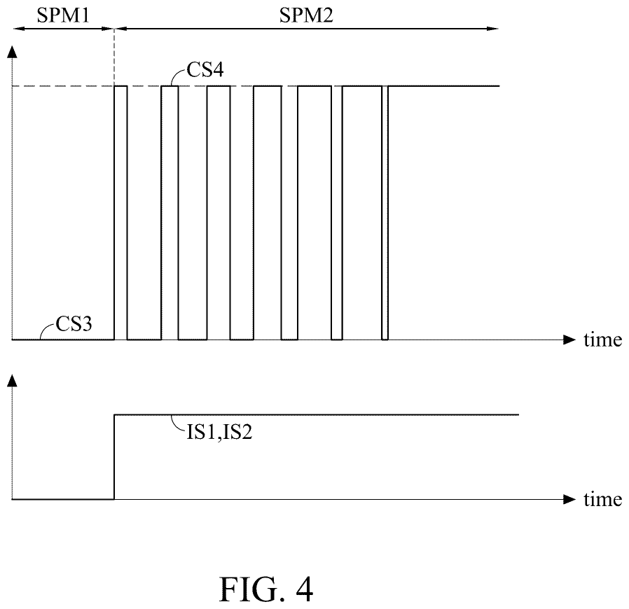

FIG. 3 is a schematic view of a motor device according another embodiment of the present invention. FIG. 4 is a waveform diagram of a first indication signal, a second indication signal, a third control signal and a fourth control signal according an embodiment of the present invention. Please refer to FIG. 3. The motor device 300 may include an inverter 110, a driver 120, a control module 130, a battery module 140, a motor module 150 and a safety logic module 310. In the embodiment, the inverter 110, the driver 120, the control module 130, the battery module 140 and the motor module 150 in FIG. 3 are the same as or similar to the inverter 110, the driver 120, the control module 130, the battery module 140 and the motor module 150 in FIG. 1. Accordingly, the inverter 110, the driver 120, the control module 130, the battery module 140 and the motor module 150 in FIG. 3 may refer to the description of the embodiment of FIG. 1, and the description thereof is not repeated herein.

The safety logic module 310 may be coupled to the control module 130. The safety logic module 310 may receive a first indication signal IS1 generated by the control module 130. In some embodiments, the first indication signal IS1 is, for example, generated when the control module 130 130 detects that the abnormality occurs in the control module 130, for example, the control module 130 may not provide the first control signal CS1 and the second control signal CS2 or may not correctly provide the first control signal CS1 and the second control signal CS2. In addition, in the first short-circuit protection mode SPM1, the first indication signal IS1 has a first voltage level, and in the second short-circuit protection mode SPM2, the first indication signal IS1 has a second voltage level, wherein the first voltage level is different from the second voltage level. In some embodiments, the first voltage level is, for example, a low voltage level, and the second voltage level is, for example, a high voltage level. The above first indication signal IS1 may be, for example, a first abnormal indication signal.

In the embodiment, after the safety logic module 310 receives the first indication signal IS1, in the first short-circuit protection mode SPM1, the safety logic module 310 may generate a third control signal CS3 to control the driver 120 to generate a third driving signal to the first switch module 111 and the second switch module 112 of the inverter 110, so that the first switch module 111 and the second switch module 112 are turned off. Then, when the first short-circuit protection mode SPM1 is switched to the second short-circuit protection mode SPM2, the safety logic module 310 may generate a fourth control signal CS4 to control the driver 120 to generate a fourth driving signal to the first switch module 111 or the second switch module 112 of the inverter 110, so that the first switch module 111 or the second switch module 112 is turned on. In the embodiment, the third control signal CS3 may be the same as the first control signal CS1 as shown in FIG. 2, the fourth control signal CS4 may be the same as the second control signal CS2 as shown in FIG. 2, the third driving signal is the same as the first driving signal, and the fourth driving signal is the same as the second driving signal.

Therefore, the transient current may be effectively reduced to avoid overheating or lifespan reduction of the power switch (such as the first switch module 111 and the second switch module 112).

In some embodiments, the priority of the safety logic module 310 in generating the third control signal CS3 and the fourth control signal CS4 is greater than the priority of the control module 130 in generating the first control signal CS1 and the second control signal CS2.

In the embodiment, the motor device 300 further includes a monitoring module 320. The monitoring module 320 may be coupled to the control module 130 and the safety logic module 310. The monitoring module 320 may monitor whether an abnormality occurs in the control module 130, for example, the control module 130 fails and may not operate normally, and when the monitoring module 320 monitors that the abnormality occurs in the control module 130, the monitoring module 320 may generate a second indication signal IS2 to the safety logic module 310. In the embodiment, the second indication signal IS2 is the same as or similar to the first indication signal IS1. That is, in the first short-circuit protection mode SPM1, the second indication signal IS2 has a first voltage level, and in the second short-circuit protection mode SPM2, the second indication signal IS2 has a second voltage level, wherein the first voltage level is different from the second voltage level. In some embodiments, the first voltage level is, for example, a low voltage level, and the second voltage level is, for example, a high voltage level. The above second indication signal IS2 may be, for example, a second abnormal indication signal.

After the safety logic module 310 receives the second indication signal IS2, in the first short-circuit protection mode SPM1, the safety logic module 310 may generate the third control signal CS3 to control the driver 120 to generate the third driving signal to the first switch module 111 and the second switch module 112 of the inverter 110, so that the first switch module 111 and the second switch module 112 are turned off. Then, when the first short-circuit protection mode SPM1 is switched to the second short-circuit protection mode SPM2, the safety logic module 310 may generate the fourth control signal CS4 to control the driver 120 to generate the fourth driving signal to the first switch module 111 or the second switch module 112 of the inverter 110, so that the first switch module 111 or the second switch module 112 is turned on.

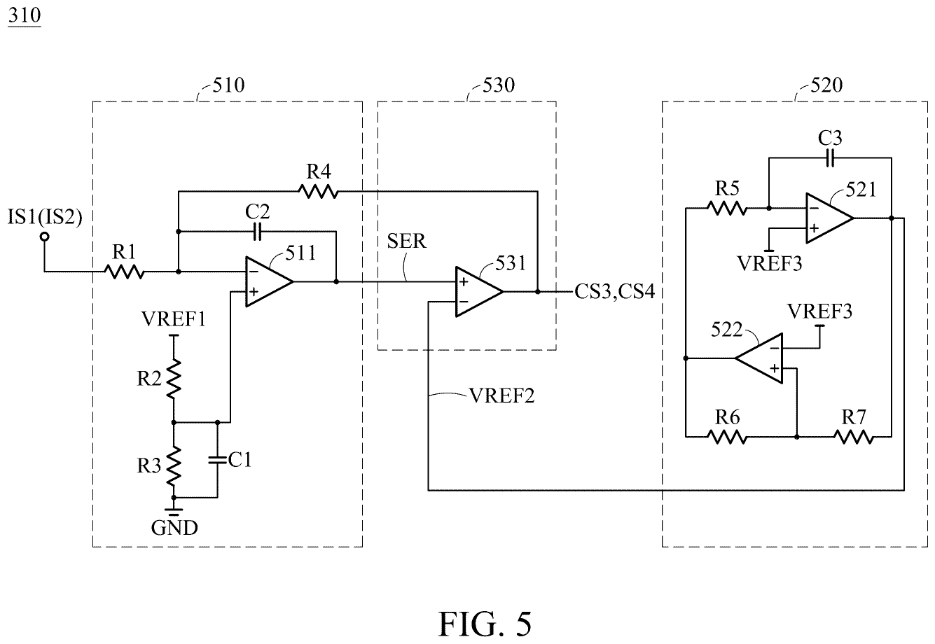

FIG. 5 is a detailed schematic view of a safety logic module 310 according an embodiment of the present invention. Please refer to FIG. 5. The safety logic module 310 may include an error amplifier 510, a reference voltage generator 520 and a comparator 530.

The error amplifier 510 may receive the first indication signal IS1 (or the second indication signal IS2) and a first reference voltage VREF1, and generate an error signal SER according to the first indication signal IS1 (or the second indication signal IS2) and the first reference voltage VREF1. The reference voltage generator 520 may generate a second reference voltage VREF2. In some embodiments, the second reference voltage VREF2 may be a triangle wave signal, but the embodiment of the present invention is not limited thereto.

The comparator 530 may be coupled to the error amplifier 510 and the reference voltage generator 520. The comparator 530 may receive the error signal SER and the second reference voltage VREF2, and generate the third control signal CS3 or the fourth control signal CS4 according to the error voltage SER and the second reference voltage VREF2.

In some embodiments, the error amplifier 510 may include first resistor R1, a second resistor R2, a third resistor R3, a first capacitor C1, a first operational amplifier (op amp) 511, a second capacitor C2 and a fourth resistor R4.

The first resistor R1 may include a first terminal and a second terminal. The first terminal of the first resistor R1 may receive the first indication signal IS1 (or the second indication signal IS2). That is, the first resistor R1 may be coupled to the control module 130. The second resistor R2 may include a first terminal and a second terminal. The first terminal of the second resistor R2 may receive the first reference voltage VREF1.

The third resistor R3 may include a first terminal and a second terminal. The first terminal of the third resistor R3 may be coupled to the second terminal of the second resistor R2. The second terminal of the third resistor R3 may be coupled to a ground terminal GND. The first capacitor C1 may include a first terminal and a second terminal. The first terminal of the first capacitor C1 may be coupled to the first terminal of the third resistor R3. The second terminal of the first capacitor C1 may be coupled to the second terminal of the third resistor R3.

The first operational amplifier 511 may include a first input terminal (such as a negative input terminal), a second input terminal (such as a positive input terminal) and an output terminal. The first input terminal of the operation amplifier 511 may be coupled to the second terminal of the first resistor R1. The second input terminal of the first operational amplifier 511 may be coupled to the second terminal of the second resistor R2. The output terminal of the first operational amplifier 511 may generate the error signal SER.

The second capacitor C2 may include a first terminal and a second terminal. The first terminal of the second capacitor C2 may be the first input terminal of the first operational amplifier 511. The second terminal of the second capacitor C2 may be coupled to the output terminal of the first operational amplifier 511. The fourth resistor R4 may include a first terminal and a second terminal. The first terminal of the fourth resistor R4 may be coupled to the first input terminal of the first operational amplifier 511.

In some embodiments, the reference voltage generator 520 may include a second operational amplifier 521, a third capacitor C3, a fifth resistor R5, a sixth resistor R6, a seventh resistor R7 and a third operational amplifier 522.

The second operational amplifier 521 may include a first input terminal (such as a positive input terminal), a second input terminal (such as a negative input terminal) and an output terminal. The first input terminal of the second operational amplifier 521 may receive a third reference voltage VREF3. The output terminal of the second operational amplifier 521 may generate the second reference voltage VREF2. In some embodiments, the third reference voltage VREF3 may be the same as the first reference voltage VREF1, such as the system voltage.

The third capacitor C3 may include a first terminal and a second terminal. The first terminal of the third capacitor C3 may be coupled to the second input terminal of the second operational amplifier 521. The second terminal of the third capacitor C3 may be coupled to the output terminal of the second operation amplifier 521. The fifth resistor R5 may include a first terminal and a second terminal. The first terminal of fifth resistor R5 may be coupled to the second input terminal of the second operational amplifier 521. The sixth resistor R6 may include a first terminal and a second terminal. The first terminal of the sixth resistor R6 may be coupled to the second terminal of the fifth resistor R5. The seventh resistor R7 may include a first terminal and a second terminal. The first terminal of the seventh resistor R7 may be coupled to the second terminal of the sixth resistor R6. The second terminal of the seventh resistor R7 may be coupled to the output terminal of the second operational amplifier 521.

The third operational amplifier 522 may include a first input terminal (such as a positive input terminal), a second input terminal (such as a negative input terminal) and an output terminal. The first input terminal of the third operational amplifier 522 may be coupled to the second terminal of the sixth resistor R6. The second input terminal of the third operational amplifier 522 may receive the third reference voltage VREF3. The output terminal of the third operational amplifier 522 may be coupled to the second terminal of the fifth resistor R5.

In some embodiments, the comparator 530 may include a fourth operational amplifier 531. The fourth operational amplifier 531 may include a first input terminal (such as a positive input terminal), a second input terminal (such as a negative input terminal) and an output terminal. The first input terminal of the fourth operation amplifier 531 may be coupled to the output terminal of the first operational amplifier 511 and may receive the error signal SER. The second input terminal of the fourth operational amplifier 531 may be coupled to the output terminal of the second operational amplifier 521 and may receive the second reference voltage VREF2. The output terminal of the fourth operational amplifier 531 may be coupled to the second terminal of the fourth resistor R4 and may generate the third control signal CS3 or the fourth control signal CS4.

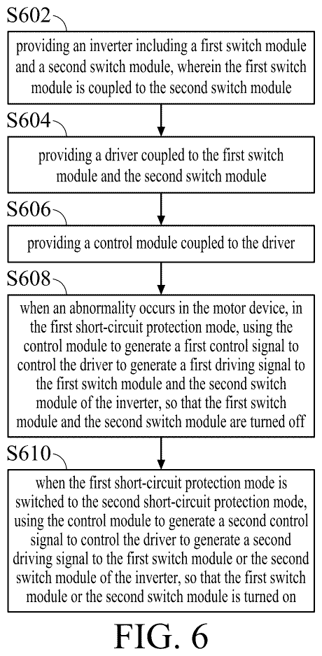

FIG. 6 is a flowchart of an operation method of a motor device according an embodiment of the present invention. In step S602, the method involves providing an inverter including a first switch module and a second switch module, wherein the first switch module is coupled to the second switch module. In step S604, the method involves providing a driver coupled to the first switch module and the second switch module. In step S606, the method involves providing a control module coupled to the driver.

In step S608, the method involves when an abnormality occurs in the motor device, in the first short-circuit protection mode, using the control module to generate a first control signal to control the driver to generate a first driving signal to the first switch module and the second switch module of the inverter, so that the first switch module and the second switch module are turned off. In step S610, the method involves when the first short-circuit protection mode is switched to the second short-circuit protection mode, using the control module to generate a second control signal to control the driver to generate a second driving signal to the first switch module or the second switch module of the inverter, so that the first switch module or the second switch module is turned on. In the embodiment, the second control signal is a pulse width modulation signal. In some embodiments, the duty cycle of the second control signal gradually increases from a first ratio to a second ratio.

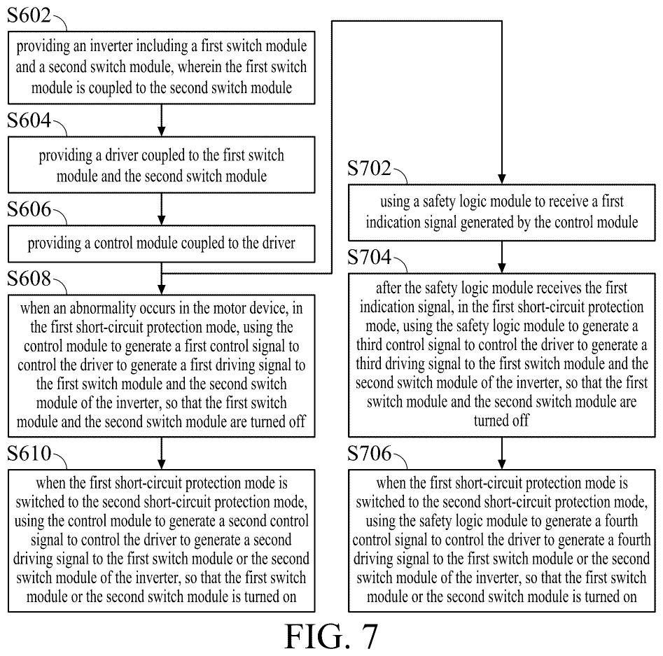

FIG. 7 is a flowchart of an operation method of a motor device according another embodiment of the present invention. In the embodiment, steps S602~S610 in FIG. 7 are the same as or similar to steps S602~S610 in FIG. 6. Accordingly, steps S602~S610 in FIG. 7 may refer to the description of the embodiment of FIG. 6, and the description thereof is not repeated herein.

In step S702, the method involves using a safety logic module to receive a first indication signal generated by the control module. In step S704, the method involves after the safety logic module receives the first indication signal, in the first short-circuit protection mode, using the safety logic module to generate a third control signal to control the driver to generate a third driving signal to the first switch module and the second switch module of the inverter, so that the first switch module and the second switch module are turned off. In step S706, the method involves when the first short-circuit protection mode is switched to the second short-circuit protection mode, using the safety logic module to generate a fourth control signal to control the driver to generate a fourth driving signal to the first switch module or the second switch module of the inverter, so that the first switch module or the second switch module is turned on. In the embodiment, the third control signal is the same as the first control signal, the third driving signal is the same as the first driving signal, the fourth control signal is the same as the second control signal, and the fourth driving signal is the same as the second driving signal.

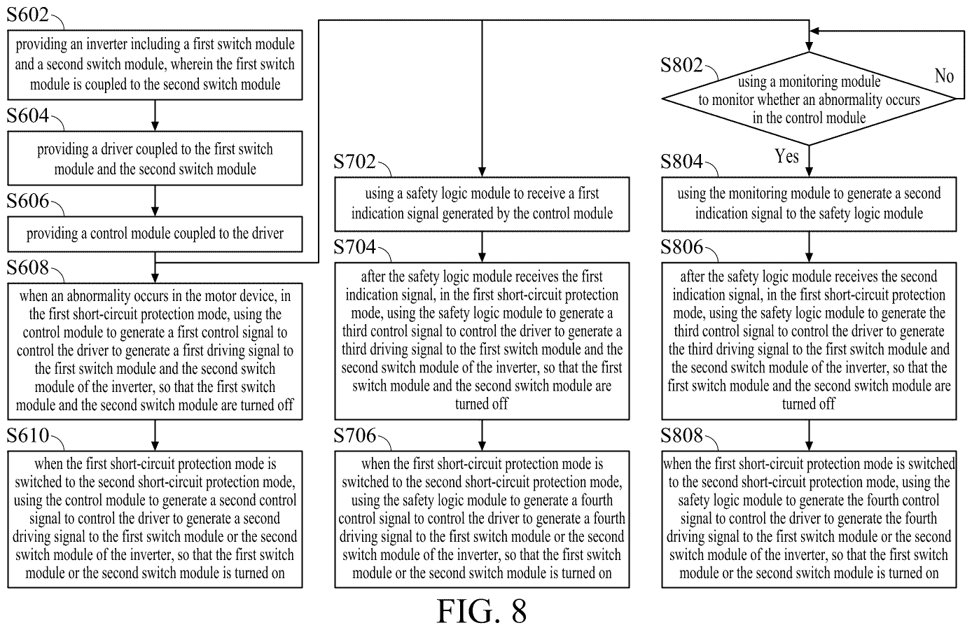

FIG. 8 is a flowchart of an operation method of a motor device according another embodiment of the present invention. In the embodiment, steps S602~S610 and S702~S706 in FIG. 8 are the same as or similar to steps S602~S610 and S702~S706 in FIG. 7. Accordingly, steps S602~S610 and S702~S706 in FIG. 8 may refer to the description of the embodiment of FIG. 7, and the description thereof is not repeated herein.

In step S802, the method involves using a monitoring module to monitor whether an abnormality occurs in the control module. When the monitoring module does not monitor the abnormality occurs in the control module, the method returns step S802, the method involves using the monitoring module to continuously monitor whether an abnormality occurs in the control module. When the monitoring module monitors that the abnormality occurs in the control module, the method performs step S804. In step S804, the method involves using the monitoring module to generate a second indication signal to the safety logic module.

In step S806, the method involves after the safety logic module receives the second indication signal, in the first short-circuit protection mode, using the safety logic module to generate the third control signal to control the driver to generate the third driving signal to the first switch module and the second switch module of the inverter, so that the first switch module and the second switch module are turned off. In step S808, the method involves when the first short-circuit protection mode is switched to the second short-circuit protection mode, using the safety logic module to generate the fourth control signal to control the driver to generate the fourth driving signal to the first switch module or the second switch module of the inverter, so that the first switch module or the second switch module is turned on.

It should be noted that the order of steps in FIG. 6, FIG. 7 and FIG. 8 is only for illustrative purposes, and is not intended to limit the order of steps of the present invention. The user may change the order of the steps above according the requirement thereof. The flowcharts described above may add additional steps or use fewer steps without departing from the spirit and scope of the present invention.

In summary, according to the motor device and the operation method thereof disclosed by the embodiment of the present invention, when the abnormality occurs in the motor device, in the first short-circuit protection mode, the control module generates the first control signal to control the driver to generate the first driving signal to the first switch module and the second switch module of the inverter, so that the first switch module and the second switch module are turned off, and when the first short-circuit protection mode is switched to the second short-circuit protection mode, the control module generates the second control signal to control the driver to generate the second driving signal to the first switch module or the second switch module of the inverter, so that the first switch module or the second switch module is turned on. The second control signal is a pulse width modulation signal. Therefore, the transient current may be effectively reduced to avoid overheating or lifespan reduction of the power switch (such as the first switch module and the second switch module), and the selection of oversized power switches can be avoided, thereby achieving the purpose of reducing costs.

While the present invention has been described by way of example and in terms of the preferred embodiments, it should be understood that the present invention is not limited to the disclosed embodiments. On the contrary, it is intended to cover various modifications and similar arrangements (as would be apparent to those skilled in the art). Therefore, the scope of the appended claims should be accorded the broadest interpretation to encompass all such modifications and similar arrangements.

1. A motor device, comprising:
an inverter, comprising a first switch module and a second switch module, wherein the first switch module is coupled to the second switch module;
a driver, coupled to the first switch module and the second switch module; and
a control module, coupled to the driver;
wherein when an abnormality occurs in the motor device, in a first short-circuit protection mode, the control module is configured to generate a first control signal to control the driver to generate a first driving signal to the first switch module and the second switch module of the inverter, so that the first switch module and the second switch module are turned off, and when the first short-circuit protection mode is switched to a second short-circuit protection mode, the control module is configured to generate a second control signal to control the driver to generate a second driving signal to the first switch module or the second switch module of the inverter, so that the first switch module or the second switch module is turned on;
wherein the second control signal is a pulse width modulation signal.

2. The motor device as claimed in claim 1, wherein a duty cycle of the second control signal gradually increases from a first ratio to a second ratio.

3. The motor device as claimed in claim 1, wherein the first switch module comprises:
a first switch unit, comprising a first terminal, a second terminal, and a control terminal, wherein the second terminal of the first switch unit is configured to generate a first voltage, and the control terminal of the first switch unit is coupled to the driver;
a second switch unit, comprising a first terminal, a second terminal, and a control terminal, wherein the first terminal of the second switch unit is coupled to the first terminal of the first switch unit, the second terminal of the second switch unit is configured to generate a second voltage, and the control terminal of the second switch unit is coupled to the driver;
a third switch unit, comprising a first terminal, a second terminal, and a control terminal, wherein the first terminal of the third switch unit is coupled to the first terminal of the second switch unit, the second terminal of the third switch unit is configured to generate a third voltage, and the control terminal of the third switch unit is coupled to the driver.

4. The motor device as claimed in claim 3, wherein the second switch module comprises:
a fourth switch unit, comprising a first terminal, a second terminal, and a control terminal, wherein the first terminal of the fourth switch unit is coupled to the second terminal of the first switch unit, and the control terminal of the fourth switch unit is coupled to the driver;
a fifth switch unit, comprising a first terminal, a second terminal, and a control terminal, wherein the first terminal of the fifth switch unit is coupled to the second terminal of the second switch unit, the second terminal of the fifth switch unit is coupled to the second terminal of the fourth switch unit, and the control terminal of the fifth switch unit is coupled to the driver;
a sixth switch unit, comprising a first terminal, a second terminal, and a control terminal, wherein the first terminal of the sixth switch unit is coupled to the second terminal of the third switch unit, the second terminal of the sixth switch unit is coupled to the second terminal of the fifth switch unit, and the control terminal of the sixth switch unit is coupled to the driver.

5. The motor device as claimed in claim 4, further comprising:
a battery module, coupled to the first terminal of the first switch unit and the second terminal of the fourth switch unit.

6. The motor device as claimed in claim 4, further comprising:
a motor module, coupled to the second terminal of the first switch unit, the second terminal of the second switch unit and the second terminal of the third switch unit, configured to receive the first voltage, the second voltage and the third voltage and to operate according to the first voltage, the second voltage and the third voltage.

7. The motor device as claimed in claim 1, further comprising:
a safety logic module, coupled to the control module, and configured to receive a first indication signal generated by the control module;
wherein after the safety logic module receives the first indication signal, in the first short-circuit protection mode, the safety logic module is configured to generate a third control signal to control the driver to generate a third driving signal to the first switch module and the second switch module of the inverter, so that the first switch module and the second switch module are turned off, and when the first short-circuit protection mode is switched to the second short-circuit protection mode, the safety logic module is configured to generate a fourth control signal to control the driver to generate a fourth driving signal to the first switch module or the second switch module of the inverter, so that the first switch module or the second switch module is turned on.

8. The motor device as claimed in claim 7, wherein the safety logic module comprises:
an error amplifier, configured to receive the first indication signal and a first reference voltage, and to generate an error signal according to the first indication signal and the first reference voltage;
a reference voltage generator, configured to generate a second reference voltage; and
a comparator, coupled to the error amplifier and the reference voltage generator, and configured to receive the error signal and the second reference voltage and to generate the third control signal or the fourth control signal according to the error voltage and the second reference voltage.

9. The motor device as claimed in claim 7, wherein the error amplifier comprises:
a first resistor, comprising a first terminal and a second terminal, wherein the first terminal of the first resistor is configured to receive the first indication signal;
a second resistor, comprising a first terminal and a second terminal, wherein the first terminal of the second resistor is configured to receive the first reference voltage;
a third resistor, comprising a first terminal and a second terminal, wherein the first terminal of the third resistor is coupled to the second terminal of the second resistor, and the second terminal of the third resistor is coupled to a ground terminal;
a first capacitor, comprising a first terminal and a second terminal, wherein the first terminal of the first capacitor is coupled to the first terminal of the third resistor, and the second terminal of the first capacitor is coupled to the second terminal of the third resistor;
a first operational amplifier, comprising a first input terminal, a second input terminal, and an output terminal, wherein the first input terminal of the operation amplifier is coupled to the second terminal of the first resistor, the second input terminal of the first operational amplifier is coupled to the second terminal of the second resistor, and the output terminal of the first operational amplifier is configured to generate the error signal;
a second capacitor, comprising a first terminal and a second terminal, wherein the first terminal of the second capacitor is coupled to the first input terminal of the first operational amplifier, the second terminal of the second capacitor is coupled to the output terminal of the first operational amplifier; and
a fourth resistor, comprising a first terminal and a second terminal, wherein the first terminal of the fourth resistor is coupled to the first input terminal of the first operational amplifier.

10. The motor device as claimed in claim 9, wherein the reference voltage generator comprises:
a second operational amplifier, comprising a first input terminal, a second input terminal, and an output terminal, wherein the first input terminal of the second operational amplifier is configured to receive a third reference voltage, and the output terminal of the second operational amplifier is configured to generate the second reference voltage;
a third capacitor, comprising a first terminal and a second terminal, wherein the first terminal of the third capacitor is coupled to the second input terminal of the second operational amplifier, and the second terminal of the third capacitor is coupled to the output terminal of the second operation amplifier;
a fifth resistor, comprising a first terminal and a second terminal, wherein the first terminal of fifth resistor is coupled to the second input terminal of the second operational amplifier;
a sixth resistor, comprising a first terminal and a second terminal, wherein the first terminal of the sixth resistor is coupled to the second terminal of the fifth resistor;
a seventh resistor, comprising a first terminal and a second terminal, wherein the first terminal of the seventh resistor is coupled to the second terminal of the sixth resistor, and the second terminal of the seventh resistor is coupled to the output terminal of the second operational amplifier; and
a third operational amplifier, comprising a first input terminal, a second input terminal, and an output terminal, wherein the first input terminal of the third operational amplifier is coupled to the second terminal of the sixth resistor, the second input terminal of the third operational amplifier is configured to receive the third reference voltage, and the output terminal of the third operational amplifier is coupled to the second terminal of the fifth resistor.

11. The motor device as claimed in claim 10, wherein the comparator comprises:
a fourth operational amplifier, comprising a first input terminal, a second input terminal, and an output terminal, wherein the first input terminal of the fourth operation amplifier is coupled to the output terminal of the first operational amplifier and configured to receive the error signal, the second input terminal of the fourth operational amplifier is coupled to the output terminal of the second operational amplifier and configured to receive the second reference voltage, and the output terminal of the fourth operational amplifier is coupled to the second terminal of the fourth resistor and configured to generate the third control signal or the fourth control signal.

12. The motor device as claimed in claim 7, further comprising:
a monitoring module, coupled to the control module and the safety logic module, wherein the monitoring module is configured to monitor whether an abnormality occurs in the control module, and when the monitoring module monitors that the abnormality occurs in the control module, the monitoring module is configured to generate a second indication signal to the safety logic module;
wherein after the safety logic module receives the second indication signal, in the first short-circuit protection mode, the safety logic module is configured to generate the third control signal to control the driver to generate the third driving signal to the first switch module and the second switch module of the inverter, so that the first switch module and the second switch module are turned off, and when the first short-circuit protection mode is switched to the second short-circuit protection mode, the safety logic module is configured to generate the fourth control signal to control the driver to generate the fourth driving signal to the first switch module or the second switch module of the inverter, so that the first switch module or the second switch module is turned on.

13. An operation method of a motor device, comprising:
providing an inverter comprising a first switch module and a second switch module, wherein the first switch module is coupled to the second switch module;
providing a driver coupled to the first switch module and the second switch module;
providing a control module coupled to the driver;
when an abnormality occurs in the motor device, in a first short-circuit protection mode, using the control module to generate a first control signal to control the driver to generate a first driving signal to the first switch module and the second switch module of the inverter, so that the first switch module and the second switch module are turned off; and
when the first short-circuit protection mode is switched to a second short-circuit protection mode, using the control module to generate a second control signal to control the driver to generate a second driving signal to the first switch module or the second switch module of the inverter, so that the first switch module or the second switch module is turned on;
wherein the second control signal is a pulse width modulation signal.

14. The operation method of the motor device as claimed in claim 13, wherein a duty cycle of the second control signal gradually increases from a first ratio to a second ratio.

15. The operation method of the motor device as claimed in claim 13, further comprising:
using a safety logic module to receive a first indication signal generated by the control module;
after the safety logic module receives the first indication signal, in the first short-circuit protection mode, using the safety logic module to generate a third control signal to control the driver to generate a third driving signal to the first switch module and the second switch module of the inverter, so that the first switch module and the second switch module are turned off; and
when the first short-circuit protection mode is switched to the second short-circuit protection mode, using the safety logic module to generate a fourth control signal to control the driver to generate a fourth driving signal to the first switch module or the second switch module of the inverter, so that the first switch module or the second switch module is turned on;
wherein the third control signal is the same as the first control signal, the third driving signal is the same as the first driving signal, the fourth control signal is the same as the second control signal, and the fourth driving signal is the same as the second driving signal.

16. The operation method of the motor device as claimed in claim 13, further comprising:
using a monitoring module to monitor whether an abnormality occurs in the control module;
when the monitoring module monitors that the abnormality occurs in the control module, using the monitoring module to generate a second indication signal to the safety logic module;
after the safety logic module receives the second indication signal, in the first short-circuit protection mode, using the safety logic module to generate the third control signal to control the driver to generate the third driving signal to the first switch module and the second switch module of the inverter, so that the first switch module and the second switch module are turned off; and
when the first short-circuit protection mode is switched to the second short-circuit protection mode, using the safety logic module to generate the fourth control signal to control the driver to generate the fourth driving signal to the first switch module or the second switch module of the inverter, so that the first switch module or the second switch module is turned on.
